(19) United States
(12) Patent Application Publication
(10) Pub. No.: US 2025/0176762 A1
(43) Pub. Date: Jun. 5, 2025

(54) FRYER WITH PIVOTABLE FILTER CARTRIDGE

(71) Applicant: PITCO FRIALATOR, INC., Bow, NH (US)

(72) Inventors: Matthew Conti, Concord, NH (US); Shawn Wayne Johnson, Allenstown, NH (US); Brian Gregory Brophy, Alton Bay, NH (US)

(73) Assignee: PITCO FRIALATOR, INC., Bow, NH (US)

(21) Appl. No.: 18/966,337

(22) Filed: Dec. 3, 2024

Related U.S. Application Data
(60) Provisional application No. 63/606,405, filed on Dec. 5, 2023.
(60) Provisional application No. 63/648,212, filed on May 16, 2024.

(51) Int. Cl. A47J 37/12; B01D 29/11; B01D 29/56; B01D 29/96

(52) U.S. Cl. CPC A47J 37/1223; B01D 29/11; B01D 29/56; B01D 29/96

(57) ABSTRACT

A fryer including a fryer vat configured to receive a volume of cooking fluid, the fryer vat having first and second bottom surfaces, a pivotable filter mount having first and second ends, a body between the first and second ends, wherein the body is configured to receive a filter cartridge having a longitudinal axis, and the first end of the pivotable filter mount is configured to pivotably couple to the fryer vat, a handle coupled to the pivotable filter mount, the handle being movable between first and second positions, wherein when the handle is in the first position, the longitudinal axis of the filter cartridge is substantially parallel to the second bottom surface, and when the handle is in the second position the longitudinal axis of the filter cartridge is substantially perpendicular to the second bottom surface.

### CROSS-REFERENCE TO RELATED APPLICATIONS

This application claims priority to provisional application No. 63/606,405, filed Dec. 5, 2023, and provisional application No. 63/648,212, filed May 16, 2024, the contents of which are incorporated herein by reference in their entirety.

### FIELD OF TECHNOLOGY

The present disclosure relates generally to filtration systems for fluid heating devices such as food fryers.

### BACKGROUND

The use of heated fluids such as oil in cooking is well known. For example, a food may be cooked by placing the food into heated oil. During the cooking process, the oil may accumulate particles from the food such as fried batter or flakes of food. This particulate may reduce heating efficiency by absorbing some of the heat in the oil instead of allowing the heat to transfer to the food for cooking/heating. Thus, more heat and/or oil may become necessary to maintain the cooking temperature and as a result more energy or fuel may be consumed to achieve the necessary oil temperature.

Previous attempts to overcome these problems have resulted in the addition of a filter to cooking systems such as fryers. In such systems, the cooking oil is pumped or pressurized to move through the filter, located outside of the fryer tank or vat, to remove particulate from the oil and allow for better temperature maintenance and extended use of the oil. Filters, often implemented as a separate apparatus from the fryer, allow fryers to perform more cooking cycles using temperature controlled oil by cycling the oil through the filter to clean the oil.

However, previous implementations of filters suffered from the drawback of being difficult to replace or requiring the fryer/cooking system to be offline for service for extended periods, reducing system availability.

Another problem experienced by existing fryers is that the particles from the food may not reach the filter, so such particles are not removed from the cooking oil. A similar problem arises when old cooking oil is drained from the fryer and replaced with new cooking oil because after the old cooking oil is drained, some particles remain on the bottom of the fryer, requiring a manual cleaning to remove the particles from the fryer before the new cooking oil is introduced.

### SUMMARY

The present disclosure provides an improved implementation of a filter for a fryer system. The fryer system includes a pivotable filter mount for holding a filter cartridge. The pivotable filter mount and filter cartridge may be disposed in a portion of a fryer vat, and positioned in a first position substantially parallel to a bottom surface of the fryer vat during operation of the fryer. When it is necessary to change the filter, the pivotable filter mount and filter cartridge may be rotated to a second position that is substantially perpendicular to the bottom surface of the fryer vat. With the pivotable filter mount in the second position, the filter cartridge may be removed from the pivotable filter mount.

A new filter may be placed on the pivotable filter mount in the second position, and the pivotable filter mount may be rotated back to its first position. A handle coupled to the pivotable filter mount may be used to move the pivotable filter mount from the first position to the second position and vice versa. The pivotable filter mount may be located within the fryer, in a filtering portion of the vat configured to substantially contain the pivotable filter mount within the vat, apart from a cooking portion of the fryer vat where fryer baskets would be retained with food for cooking during operation of the fryer. The pivotable filter mount provides for fast and easy filter changeover with minimal downtime.

A lift screen may be configured proximate to the pivotable filter mount, e.g., above the filter, to catch larger food particles such as crumbs in the cooking fluid. To access the filter on the pivotable filter mount beneath the lift screen, the lift screen may be removed from the fryer vat, and particles/crumbs in the filter screen may be discarded. With the lift screen removed the pivotable filter mount may be moved from the first position to the second position and vice versa.

In an illustrative embodiment, the fryer vat may be configured to have first and second bottom surfaces, where the second bottom surface is lower than the first bottom surface relative to a top surface of the fryer vat. The pivotable filter mount may be disposed in the area above the second bottom surface. The lift screen (also referred to as a crumb screen) may be positioned above the pivotable filter mount and filter cartridge to catch larger crumbs and particulates before they reach the filter cartridge. The cooking vat may include a cooking portion, and the lift screen may separate the cooking portion from a filtering portion containing the pivotable filter mount and filter cartridge. When the lift screen is in a condition to have crumbs removed, the lift screen may be removed from the fryer vat and the crumbs may be discarded from the lift screen. In an embodiment including the lift screen, access may be provided to the pivotable filter mount and filter cartridge in the filtering portion of the cooking vat once the lift screen is removed.

By way of example, a fryer is described using an embodiment of the pivotable filter mount. However, a person of ordinary skill in the art would understand that the present disclosure may be adapted for use with various other devices within and outside of the cooking industry. The pivotable filter mount may be used as described with any of various devices requiring the use of a filtration media that requires replacement or service.

The above summary has outlined, rather broadly, some features and advantages of the present disclosure in order that the detailed description that follows may be better understood. Additional features and advantages of the disclosure will be described below. It should be appreciated by those skilled in the art that this disclosure may be readily utilized as a basis for modifying or designing other structures/processes/steps for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization, method of operation, or resultant product, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

Embodiments of devices, systems, and methods are illustrated in the figures of the accompanying drawings which are meant to be exemplary and non-limiting, in which like references are intended to refer to like or corresponding parts, and in which:

FIG. 1 a perspective view of a fryer vat and pivotable filter mount according to the disclosure disposed in a second position substantially perpendicular to a bottom of the fryer vat.

FIG. 2 is a top-down, plan view of the fryer vat and pivotable filter mount according to the disclosure, where the lift screen is partially transparent so that the filter on the pivotable filter mount can be seen.

FIG. 3 is a front-side, plan view of the fryer vat and pivotable filter mount according to the disclosure, where a front wall of the fryer vat is transparent so that the filter on the pivotable filter mount can be seen.

FIG. 4 is a back-side, plan view of the fryer vat and pivotable filter mount according to the disclosure, where the pivotable filter mount is disposed in a first position and the back wall of the fryer vat is transparent so that the filter on the pivotable filter mount can be seen.

FIG. 5 is a back-side, plan view of the fryer vat and pivotable filter mount according to the disclosure, where the pivotable filter mount is disposed in a second position and the back wall of the fryer vat is transparent so that the filter on the pivotable filter mount can be seen.

FIG. 6 is a cross-sectional first side view of the fryer vat and pivotable filter mount, where the pivotable filter mount is disposed in a second position according to the disclosure, and no filter is disposed on the pivotable filter mount.

FIG. 7 is a perspective view of the fryer vat and pivotable filter mount in the second position, with the filter removed from the pivotable filter mount according to the disclosure.

### DETAILED DESCRIPTION

The detailed description of aspects of the present disclosure set forth herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, references to a singular embodiment may include plural embodiments, and references to more than one component may include a singular embodiment.

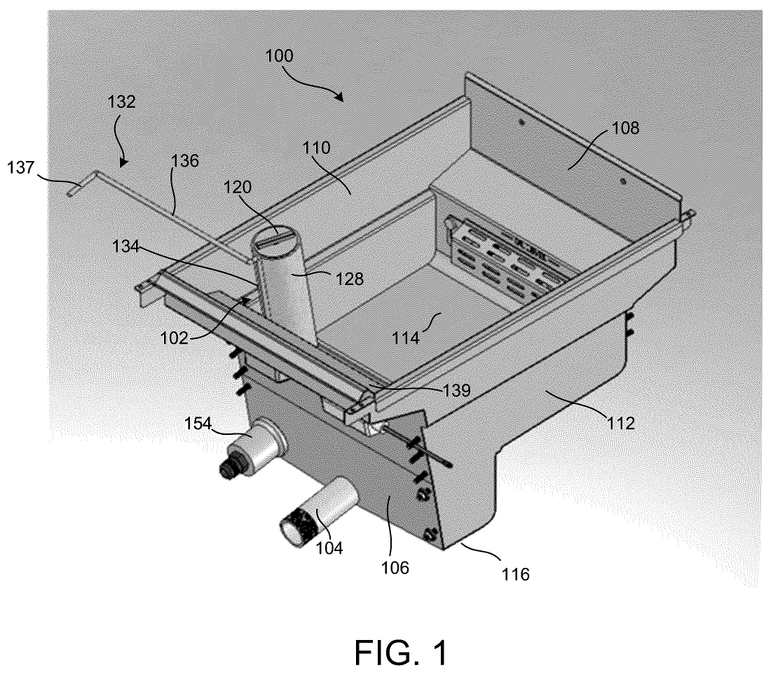

FIG. 1 depicts an illustrative embodiment of a fryer vat 100 according to aspects of the present application. As seen in the perspective view of FIG. 1, the fryer vat 100 includes a pivotable filter mount 102 disposed in the fryer vat 100. The pivotable filter mount 102 is configured to receive a filter cartridge 128 that includes filter media. The fryer vat 100 includes a first wall 106, a second wall 108, a left/first side wall 110, and a right/second side wall 112. The fryer vat 100 may include a drain 104 to allow cooking fluid to be drained from the fryer vat 100. A recirculation tube 154 may recirculate filtered fluid back into the fryer vat 100.

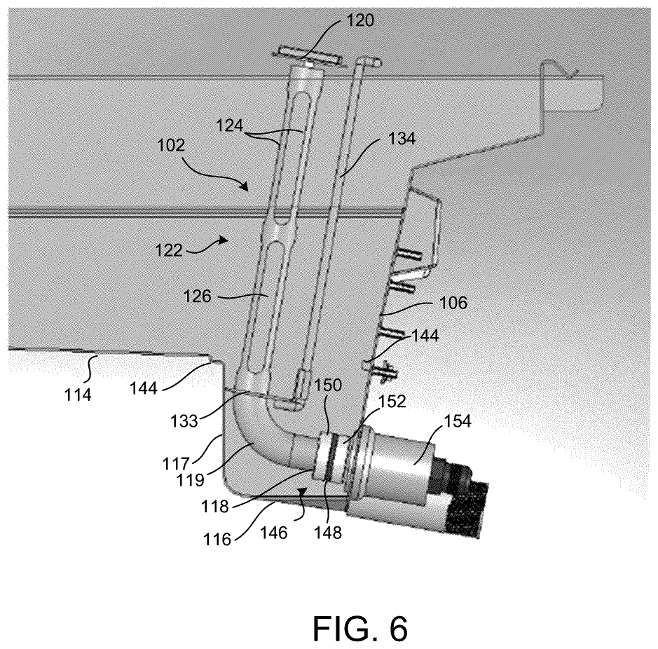

The fryer vat 100 may include a first bottom 114 and a second bottom 116. The first bottom 114 and the second bottom 116 may be connected by a second back wall 117 (best seen in FIG. 6). Referring back to FIG. 1, the area in the fryer vat 100 above the first bottom 114 may define a first volume for cooking oil with that first volume being configured to be the cooking portion of the fryer vat 100. The area above the second bottom 116 may define a second volume of cooking oil, such as a filtering portion, defined for housing a pivotable filter mount 102, configured to receive a filter cartridge 128 (and lift screen not shown in this view, but as described in detail hereinafter). The second bottom 116 may have a depth greater than the first bottom 114, relative to a top portion of the fryer vat 100. The second bottom 116 may be a flat surface substantially parallel to the first bottom 114. It should also be appreciated that the second bottom 116 may be sloped, with the lowest portion of the second bottom 116 proximal to the first wall 106 to allow for removal of substantially all of the cooking fluid through the drain 104.

As illustrated in FIG. 1, the pivotable filter mount 102 with the filter cartridge 128 disposed thereon is shown in a second position substantially perpendicular to the second bottom surface 116. When it is necessary to service, e.g., change the filter cartridge 128, the pivotable filter mount and filter cartridge may be rotated to the second position that is substantially perpendicular to the second bottom surface 116 of the fryer vat 100. With the pivotable filter mount 102 in the second position, the filter cartridge may be removed from the pivotable filter mount. A new filter may be placed on the pivotable filter mount in the second position, and the pivotable filter mount may be rotated back to its first position (substantially parallel to the second bottom surface 116). As illustrated, the pivotable filter mount 102 may be located within the fryer vat 100, in a filtering portion of the fryer vat 100 configured to substantially contain the pivotable filter mount 102 within the fryer vat 100, apart from a cooking portion of the fryer vat 100 where fryer baskets (not shown) may be retained with food for cooking during operation of the fryer.

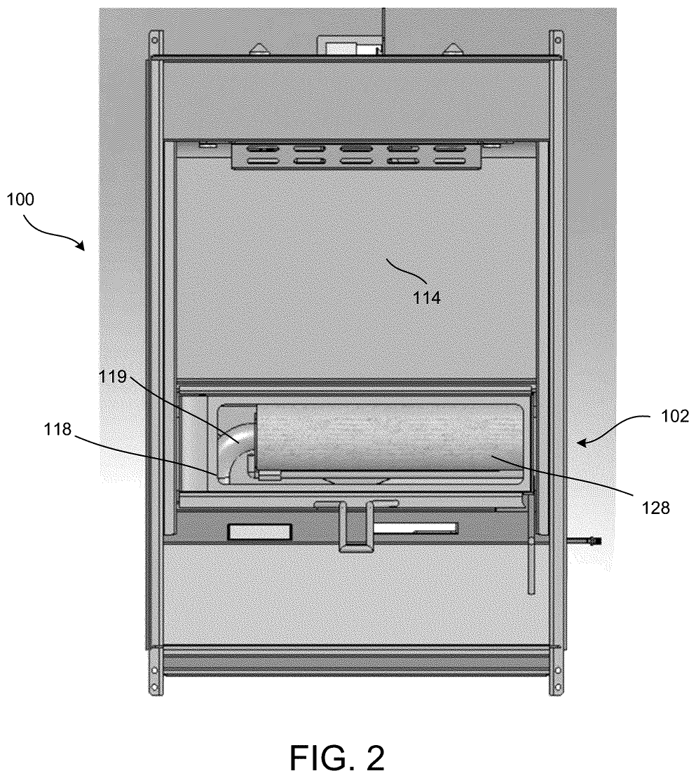

A handle 132 coupled to the pivotable filter mount 102 may be used to move the pivotable filter mount 102 from the first position to the second position and vice versa. The handle 132 may be attached to the pivotable filter mount 102. The pivotable filter mount 102 may rotate about a first end (shown in FIG. 2 as first end 118) of the pivotable filter mount 102. The handle 132 may include a first portion 134 that extends substantially parallel to the axis of the pivotable filter mount 102 and is connected to a second end 120 of the pivotable filter mount 102. A second portion 136 of the handle 132 may extend substantially perpendicular or orthogonal from the first portion 134. The second portion 136 may extend out of the fryer vat 100 so that a user may grasp the handle 132 and pivot the pivotable filter mount 102 from the first position to the second position without reaching into the cooking fluid held in the fryer vat 100. A stop 137 may extend from the second portion 136 to rest against an external surface 139 of the fryer vat 100 when the pivotable filter mount 102 is in the first position. In an illustrative embodiment, the external surface 139 may be above the fluid level of the cooking fluid in the fryer vat 100.

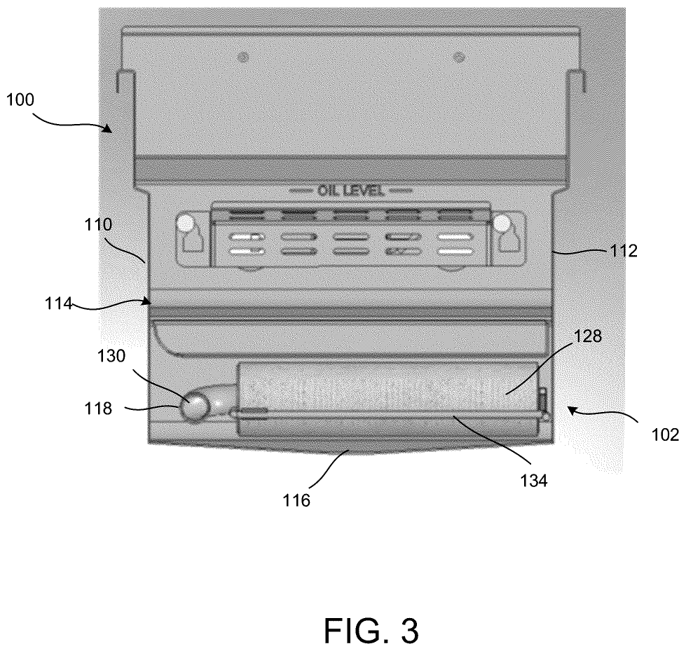

As illustrated in FIGS. 2, 3 and 4, the depth of the second bottom 116 relative to a top of the fryer vat 100 may be such that the pivotable filter mount 102 may be positioned proximal to the second bottom 116 and the entirety of the pivotable filter mount 102 is located lower than the first bottom 114 (as shown in FIG. 3). In an illustrative embodiment, the pivotable filter mount 102 may be located at a greater depth in the fryer vat 100 than the first bottom 114 relative to a top surface of the fryer vat 100.

The pivotable filter mount 102 may be pivoted about the first end 118 of the pivotable filter mount 102. An angled portion 119 of the pivotable filter mount 102 may be included to form a right angle between the first end 118 and the second end 120 of the pivotable filter mount 102. The angled portion 119 may form any angle from approximately 0 to approximately 90 degrees within the scope of this disclosure.

A lift screen 138 may be positioned above the pivotable filter mount 102 relative to a top surface of the fryer vat 100. The lift screen 138 may include a lift screen handle 140 and a screen portion 142. The screen portion 142 may be sized to filter out larger crumbs or particulate from the fluid before the fluid reaches the filtration cartridge 128 disposed on the pivotable filter mount 102. The handle 140 may extend above the fluid height in the fryer vat 100 to allow a user to grasp and remove the lift screen 138 prior to servicing the filter cartridge 128.

A lumen, or interior flow path, 130 of the pivotable filter mount 102, may form an aperture for flowing filtered fluid through the pivotable filter mount 102 and out a recirculation tube 154.

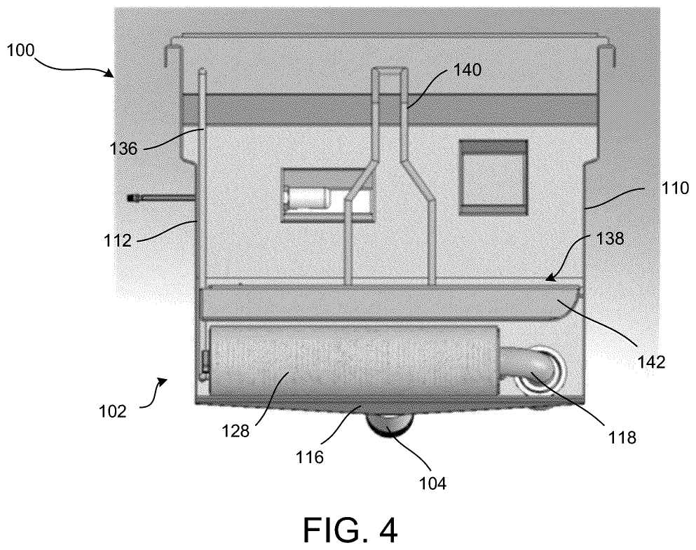

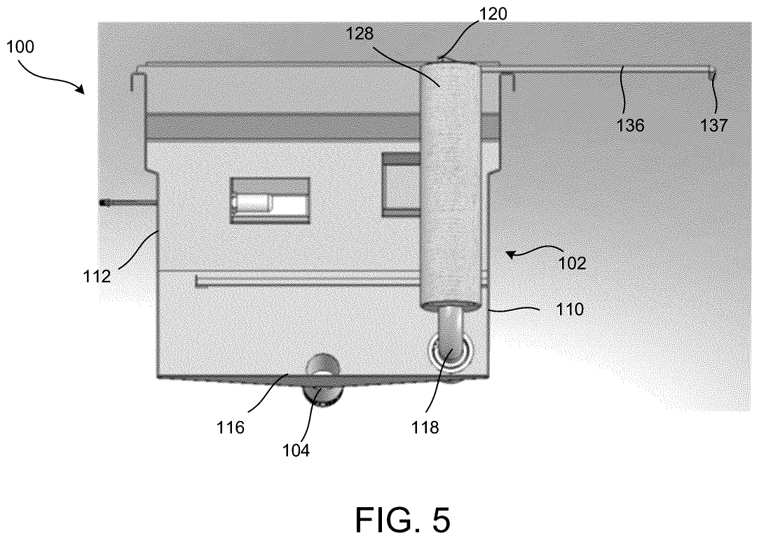

The pivotable filter mount 102 may be pivoted between a first position, as illustrated in FIG. 4, and a second position, as illustrated in FIG. 5. The pivotable filter mount 102 may be in the first position when the pivotable filter mount 102 is disposed above the second bottom 116 and the longitudinal axis of the pivotable filter mount 102 is substantially parallel to the second bottom 116, as shown in FIG. 4. The pivotable filter mount 102 may be in the second position when the longitudinal axis of the pivotable filter mount is substantially perpendicular to the second bottom 116, as shown in FIG. 5. The pivotable filter mount 102 may also be disposed at any angle between the first and second positions. The pivotable aspect of the pivotable filter mount 102 allows for the filter cartridge 128 to be readily changed with minimal downtime of the fryer.

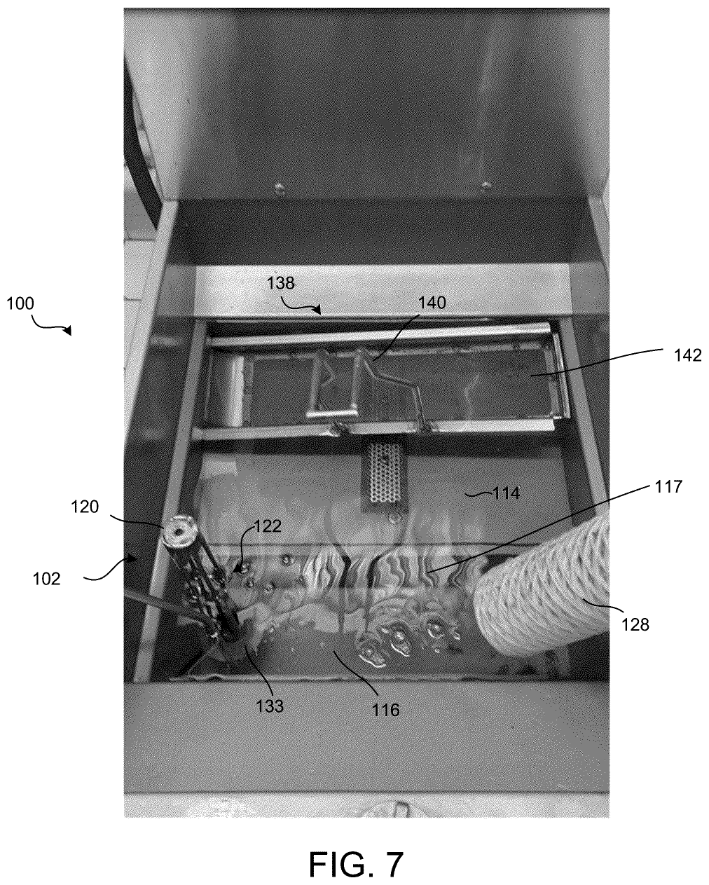

As illustrated in FIGS. 6 and 7, the pivotable filter mount 102 includes a first end 118, a second end 120, a flange 133, an angled portion 119, and a body 122. The body 122 includes arms 124 that are configured to receive a filter cartridge 128. The filter cartridge 128 may be a hollow cylinder having a longitudinal axis extending along the length of the cylinder. A person of ordinary skill in the art would understand that the filter cartridge may be of any shape without departing from the scope of the present disclosure.

The filter cartridge 128 may be open on at least one of its ends in order to be slidably received by the pivotable filter mount 102. The arms 124 and the filter cartridge 128 define an internal volume 126 when the filter cartridge 128 is received by the body 122. Cooking fluid may pass through the filter media of the filter cartridge 128 from outside of the filter cartridge 128 into the internal volume 126 to form a filtered fluid. The filter cartridge 128 may be configured to slide over the arms 124 of the body 122 and be retained on the body 122 by frictional engagement. The flange 133 may provide an abutment surface for the open end of the filter cartridge 128, and prevent cooking fluid from entering the internal volume 126 without passing through the filter media of the filter cartridge 128. It should be understood that an embodiment of the flange 133 may have a diameter that corresponds to the inner diameter of the filter cartridge 128 so that the filter cartridge 128 may slide over the edge of the flange 133 and be in contact with an edge of the flange 133.

As shown in FIGS. 6 and 7, the body 122 may include arms 124 that extend substantially between the flange 133 and the second end 120 of the pivotable filter mount 102. While four arms 124 are illustrated in an illustrative embodiment, it should be understood that the body 122 could include more or fewer arms, including a single arm within the scope of this disclosure. The arms 124 may frictionally engage the interior of the filter cartridge 128 to retain the filter cartridge 128 in a filtering position on the pivotable filter mount 102. It should be appreciated that the arms 124 may not be in direct engagement with the filter cartridge 128. For example, a single arm 124 could form the body 122, and the filter cartridge 128 could be retained relative to the pivotable filter mount 102 by frictional engagement with the second end 120 of the pivotable filter mount 102, where an internal volume 126 is defined only by the interior surface of the filter cartridge 128. Other mechanisms for attaching the filter cartridge 128 to the pivotable filter mount 102 would also be understood by a person of ordinary skill in the art as within the bounds of the present disclosure.

An illustrative embodiment of the filter cartridge 128 may be cylindrical in shape with two open ends; however other shapes may be substituted without departing from the scope of the present disclosure. The filter cartridge 128 includes a longitudinal axis that extends along its length. The filter cartridge 128 is composed of a filter media that permits cooking fluid to pass through the filter, such that the cooking fluid passes through the filter media and into the internal volume 126 of the body 122, while food crumbs or other particles in the cooking fluid are substantially restricted from passing through the filter media. It should be understood that the filter cartridge may alternatively include a closed end that corresponds to the second end 120, such that the second end 120 would be inside the filter cartridge 128 when the filter cartridge 128 is received by the pivotable filter mount 102.

The first end 118 of the pivotable filter mount 102 may couple to the first wall 106 of the fryer vat 100. However, it should be appreciated that the first end 118 could alternatively be coupled to the second wall 108, left side wall 110, or right side wall 112. The first end 118 of the pivotable filter mount 102 may form a lumen 130 that provides fluid communication and allows filtered fluid to pass from the internal volume 126 of the body 122 to the recirculation tube 154 and a recirculating pump (not shown). The angled portion 119 is proximal to the first end 118 and may be angled or bent such that the longitudinal axis of the pivotable filter mount 102 is substantially perpendicular to the first wall 106, when the filter mount 102 is disposed in the fryer vat 100 in the first position proximal to the second bottom 116. The angled portion 119 may include an angle of approximately 0 to 90 degrees, preferably about 90 degrees. The angled portion 119 provides a fluid connection between the internal volume 126 and the lumen 130.

The second end 120 may be any of various shapes, for example a circular or oval shape, that corresponds to the inner diameter of the cross section of the filter cartridge 128. It should be understood that the second end 120 may have another geometric shape that preferably corresponds to the inner cross section of the filter cartridge 128 without departing from the scope of the disclosure. The second end 120 may be configured to frictionally engage the filter cartridge 128 and retain the filter cartridge 128 in a filtering position on the pivotable filter mount 102. The second end 120 is preferably sized so that cooking fluid cannot pass between the edges of the second end 120 and the filter cartridge 128, without passing though the filtration media when the filter cartridge 128 is in the filtering position.

The pivotable filter mount 102 may include a handle 132 for moving the pivotable filter mount 102 between the first position and the second position. The handle 132 may be coupled to a flange 133. In an illustrative embodiment, the handle 132 may be coupled to the body 122 or the angled portion 119 using various means such as a C-clip, welding, rivets, threaded fasteners, etc. The handle 132 may be selectively removable from the pivotable filter mount 102. The handle 132 may include a first portion 134 that extends substantially parallel to the axis of the body 122 of the pivotable filter mount 102 and a second portion 136 that extends from the first portion 134. The second portion 136 may be substantially perpendicular to the first portion 134. The second portion 136 may extend out of the fryer vat 100 so that a user may grasp the handle 132 to pivot the pivotable filter mount from the first position to the second position without reaching into the cooking fluid held in the fryer vat 100.

A stop 137 may extend from the second portion 136 and be substantially perpendicular to the second portion 136. The stop may rest against an external surface 139 of the fryer vat 100 when the pivotable filter mount 102 and handle 132 are in the first position. The stop 137 may prevent the pivotable filter mount 102 from rotating past the first position and contacting the second bottom 116 as such contact may decrease the effectiveness of the filter cartridge 128. The stop 137 may also provide a grasping point for a user to move the pivotable filter mount 102 from the first position to the second position. It should be understood that the first portion 134 of the handle 132 may frictionally engage the external surface 139 of the filter cartridge 128 to assist in retaining the filter cartridge 128 on the pivotable filter mount 102.

The lift screen 138 may include a lift screen handle 140 and a screen portion 142. The screen portion 142 may provide a first filtration of the cooking fluid before the cooking fluid reaches the filter cartridge 128. The lift screen 138 may be positioned above the pivotable filter mount 102 in the fryer vat 100 so that larger food particles (also referred to a crumbs) are filtered before reaching the filter cartridge 128. The fryer vat 100 may include at least one ledge 144 to receive the lift screen 138. The lift screen 138 may rest on the ledge 144 when it is disposed in the fryer vat 100. The ledge 144 may include an indent or depression in the first bottom 114. The ledge 144 may extend along the first wall 106 to support the lift screen 138.

In an illustrative embodiment, the at least one ledge 144 may be lower than the first bottom 114 so that the top of the screen portion 142 is co-planar with the first bottom 114 (or lower than the first bottom 114) so food particles moving along the first bottom 114 reach the screen portion 142 and accumulate on the lift screen 138. The accumulated food particles may be removed with the lift screen 138 when the lift screen 138 is removed by a user.

A user may remove the lift screen 138 from the fryer vat 100 by grasping the lift screen handle 140, remove any accumulated food particles that may be present on the screen portion 142 (for example, by shaking the lift screen 138), and return the lift screen 138 to the fryer vat 100. It should be understood that the openings in the screen portion 142 may be sized to allow smaller food particles to pass through, while preventing any larger food particles and debris from passing through the screen portion 142, thereby reducing the food particles reaching the filter cartridge 128 and prolonging the filtration media's service life.

A user may pivot the pivotable filter mount 102 about the first end 118 from the first position to the second position, as described hereinbefore. When the pivotable filter mount 102 is disposed in the second position, a user may remove the filter cartridge 128 and replace a used filter cartridge 128 with a new filter cartridge 128. The user may grasp the filter cartridge 128 to remove the filter cartridge 128 off the body 122 of the pivotable filter mount 102. A new filter cartridge 128 may be placed onto the body 122 of the pivotable filter mount 102, and the pivotable filter mount 102 may be returned to the first position from the second position by pivoting the pivotable filter mount 102 about the first end 118.

The first end 118 of the pivotable filter mount 102 may be coupled to the first wall 106 by a coupling 146. The coupling 146 may include an O-ring 148 disposed between a first coupling portion 150 and a second coupling portion 152. The first coupling portion 150 and the second coupling portion 152 may be coupled together and rotatable relative to each other. The coupling 146 may be coupled to a recirculation tube 154. The coupling 146 and the recirculation tube 154 may be coupled together by a threaded connection. In an embodiment, the coupling 146 and the recirculation tube 154 may be coupled by a quick-disconnect fitting such as a ⅛th turn quick disconnect by Gemini Valve of Raymond, NH. The cooking fluid that passes through the recirculation tube 154 (that is, the filtered fluid) contains less food particulates compared to the cooking fluid in the fryer vat 100. It should be understood that the filtered cooking fluid may be heated and/or returned directing to the fryer vat 100 after filtering through the filter cartridge 128. It should be understood that the characteristics of the filter media, such as pore size, may be selected by a user based on the desired cooking characteristics.

Although the fryer vat 100 described herein is described as having a first bottom 114 and second bottom 116 that are substantially flat and substantially parallel to each other, it should be appreciated an embodiment of the second bottom 116 may be a shape other than flat, e.g., it could include two surfaces forming a V-shape, where the lowest part of the V-shape is proximal to the drain 104. It should also be appreciated that the second bottom 116 may have a single surface that slants toward the left wall 110 or the right wall 112 of the fryer vat 100, and the drain 104 may be positioned in an alternative location, e.g., on the first wall proximal to either the left wall 110 or the right wall 112. It should be appreciated that the fryer vat 100 may have various geometries configured to receive a volume of cooking fluid, and that the walls may be disposed at various angles relative to each other.

Although embodiments have been described in detail for purposes of illustration, various modifications may be made without departing from the scope and spirit of the present disclosure. Accordingly, the disclosure is not to be limited by the examples presented herein, but is envisioned as encompassing the scope described in the appended claims and the full range of equivalents of the appended claims. The detailed description and drawings are merely illustrative of the present disclosure rather than limiting, the scope of the present disclosure being defined by the appended claims and equivalents thereof.

Benefits, other advantages, and solutions to problems have been described herein with regard to specific embodiments. However, the benefits, advantages, solutions to problems, and elements that may cause any benefit, advantage, or solution to occur or become more pronounced are not to be construed as critical, required, or essential features or elements of the disclosure.

It should be understood that when an element is referred to as being “connected” or “coupled” to another element (or variations thereof), it can be directly connected or coupled to the other element or intervening elements may be present.

What is claimed is:

1. A fryer, comprising:
a fryer vat configured to receive a volume of cooking fluid, the fryer vat having first and second bottom surfaces;
a pivotable filter mount having first and second ends, a body between the first and second ends, wherein the body is configured to receive a filter cartridge having a longitudinal axis, and the first end is configured to pivotably couple to the fryer vat,
a handle coupled to the pivotable filter mount, the handle being movable between first and second positions, wherein when the handle is in the first position, the longitudinal axis of the filter cartridge is substantially parallel to the first bottom surface, and when the handle is in the second position the longitudinal axis of the filter cartridge is substantially perpendicular to the second bottom surface.

2. The fryer of claim 1, wherein the pivotable filter mount is disposed proximal to the second bottom surface.

3. The fryer of claim 1, wherein the first bottom surface has a first depth relative to a top portion of the fryer, the second bottom surface has a second depth relative to the top portion of the fryer, and the first depth is less than the second depth.

4. The fryer of claim 1, further comprising a coupling configured to couple the pivotable filter mount to the fryer vat.

5. The fryer of claim 1, wherein the pivotable filter mount includes an angled portion proximal to the first end.

6. The fryer of claim 1, wherein the pivotable filter mount includes a flange configured to abut the filter cartridge.

7. The fryer of claim 1, wherein the body includes arms that define an internal volume.

8. The fryer of claim 1, wherein the pivotable filter mount rotates the filter cartridge in a range of approximately 0 degrees to approximately 90 degrees relative to the second bottom surface.

9. The fryer of claim 1, wherein the handle includes first and second portions, the first portion extends substantially parallel to the longitudinal axis of the filter cartridge, and the second portion extends substantially orthogonal to the first portion.

10. The fryer of claim 9, wherein the handle includes a stop coupled to the second portion.

11. The fryer of claim 1, further comprising a lift screen disposed in the fryer vat between a first volume and the pivotable filter mount, wherein the area above the first bottom and the lift screen defines the first volume.

12. The fryer of claim 11, wherein the lift screen is disposed above the pivotable filter mount relative to the top portion of the fryer.

13. The fryer of claim 11, wherein the lift screen includes a lift screen handle that extends out of the fryer vat.

14. The fryer of claim 1, wherein the body of the pivotable filter mount is configured to receive the filter cartridge, wherein the filter cartridge is substantially cylindrical.

15. A pivotable filter mount for removing particulates from cooking fluid in a fryer vat adapted to receive a volume of cooking fluid, the pivotable filter mount comprising:
opposing first and second ends, wherein the first end is adapted to pivotably couple to a wall of the fryer vat;
an angled portion proximal to the first end; and
a body extending between the angled portion and the second end, the body having arms that define an interior volume of the pivotable filter mount, and the body is configured to hold a removable filter cartridge.

16. The pivotable filter mount of claim 15, further comprising a flange adjacent to the angled portion that is configured to abut the removable filter cartridge.

17. The pivotable filter mount of claim 15, wherein the body includes arms that are configured to frictionally engage the removable filter cartridge.

18. The pivotable filter mount of claim 15, wherein the removable filter cartridge has a filter cartridge cross-section and the second end of the pivotable filter mount is includes a second end cross-section that corresponds to the removable filter cartridge cross-section.

19. The pivotable filter mount of claim 15, wherein the angled portion has a bend angle of about 90 degrees.

20. The pivotable filter mount of claim 15, wherein the filter cartridge is cylindrical.
